(19) United States
(12) Patent Application Publication
(10) Pub. No.: US 2026/0175487 A1
(43) Pub. Date: Jun. 25, 2026

(54) INJECTION MOLDING PROCESS INCLUDING IN-MOLD LASER GATE CUTTING

(71) Applicant: GM GLOBAL TECHNOLOGY OPERATIONS LLC, Detroit, MI (US)

(72) Inventors: Liying QI, Troy, MI (US); David Francis MILLER, Bloomfield Hills, MI (US); Junjie MA, Novi, MI (US)

(21) Appl. No.: 18/988,161

(22) Filed: Dec. 19, 2024

(51) Int. Cl. B29C 45/16; B23K 26/142; B29C 45/08; B29K 33/00; B29K 69/00; B29L 11/00

(52) U.S. Cl. CPC B29C 45/16; B23K 26/142; B29C 45/08; B29C 2045/1693; B29K 2033/12; B29K 2069/00; B29K 2995/0021; B29K 2995/0026; B29L 2011/0016

(57) ABSTRACT

A method for molding a part includes providing a mold including a first mold half and a second mold half defining a first cavity and a second cavity. The first cavity defines a shape of a first part portion and a projecting portion. The second cavity defines a shape of a second part portion that at least partially surrounds the first part portion. The method includes closing the first mold half and the second mold half; injecting a first shot of molten plastic using a shot gate located along the projecting portion to mold the first part portion of the molded part, opening the second mold half; trimming the projecting portion using a laser; rotating at least one of the first mold half and the second mold half; closing the second mold half; and injecting a second shot into the mold to form the second part portion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to injection molding of parts, and more particularly to a multi-shot injection molding process including in-mold cutting and removal of a shot gate using a laser.

Parts can be made using an injection molding tool including first and second mold halves defining a cavity in the shape of a molded part. The first and second mold halves are closed and molten plastic is injected into the cavity between the mold halves. The first or second mold half is opened and the part is ejected. The process is repeated for another part.

### SUMMARY

A method for molding a part includes providing a mold including a first mold half and a second mold half defining a first cavity and a second cavity. The first cavity defines a shape of a first part portion and a projecting portion. The second cavity defines a shape of a second part portion that at least partially surrounds the first part portion. The method includes closing the first mold half and the second mold half; injecting a first shot of molten plastic using a shot gate located along the projecting portion to mold the first part portion of the molded part, opening the second mold half; trimming the projecting portion using a laser; rotating at least one of the first mold half and the second mold half; closing the second mold half; and injecting a second shot into the mold to form the second part portion.

In other features, the projecting portion is removed by the laser while the first part portion is located in one of the first mold half and the second mold half. The first shot and the second shot comprise transparent plastic. The first shot and the second shot comprise polymethyl methacrylate (PMMA). The first shot and the second shot comprise polycarbonate. The first shot and the second shot comprise plastic having different colors.

In other features, the laser comprises a carbon dioxide (CO2) laser. The laser operates at a wavelength greater than 4 micrometers. A robot is configured to position the laser relative to the first mold half and the projecting portion of the first part portion. The method includes using vacuum to evacuate vapor generated during the laser trimming of the projecting portion.

A multi-shot injection molding tool for producing a molded part includes a mold including a first mold half and a second mold half defining a first cavity defines a shape of a first part portion and a projecting portion and a second cavity defining a shape of a second part portion that at least partially surrounds the first part portion. The multi-shot injection molding tool further includes a laser, a positioning device, a first injector, and a second injector. A controller is configured to cause the positioning device to close the first mold half and the second mold half; cause the first injector to inject a first shot of molten plastic using a shot gate located along the projecting portion to mold the first part portion of the molded part, cause the positioning device to open the second mold half; cause the positioning device and the laser to trim the projecting portion; cause the positioning device to rotate at least one of the first mold half and the second mold half; cause the positioning device to close the second mold half; and cause the second injector to inject a second shot into the mold to form the second part portion.

In other features, the projecting portion is removed by the laser while the first part portion is located in one of the first mold half and the second mold half. The first shot and the second shot comprise transparent plastic. The first shot and the second shot comprise polymethyl methacrylate (PMMA). The first shot and the second shot comprise polycarbonate. The first shot and the second shot comprise plastic having different colors.

In other features, the laser comprises a carbon dioxide (CO2) laser. The laser operates at a wavelength greater than 4 micrometers. A vacuum nozzle is configured to evacuate vapor generated during laser trimming of the projecting portion. The molded part comprises a taillight lens for a vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a first part portion of a molded part that is molded using a first shot in a multi-shot injection molding tool;

FIG. 2 is a perspective view of an example of the molded part of FIG. 1 after a second shot of the multi-shot injection molding tool is molded around the first part portion;

FIG. 3 is a perspective view of an example of a first part portion of a molded part that is molded using a first shot in a multi-shot injection molding tool according to the present disclosure;

FIG. 4 is a perspective view of an example of the molded part of FIG. 1 after a second shot of the multi-shot injection molding tool is molded around the first part portion according to the present disclosure;

FIG. 5A is a side cross section of an example of an injection molding tool including a first mold half and a second mold half according to the present disclosure;

FIG. 5B is a perspective view of an example of a multi-shot injection molding tool according to the present disclosure;

FIG. 5C is a functional block diagram of a control system for the multi-shot injection molding tool according to the present disclosure;

FIG. 6 is a functional block diagram of an example of a coaxial vacuum nozzle according to the present disclosure; and

FIG. 7 is a flowchart of an example of a method for molding a part using a multi-shot injection molding tool according to the present disclosure.

In the drawings, reference numbers may be reused to identify similar and/or identical elements.

### DETAILED DESCRIPTION

While the injection molding process according to the present disclosure is described herein in the context of molded parts for vehicles, the injection molding process can be used to make parts for other mobile applications and/or stationary applications.

Multi-shot injection molding tools are used to produce plastic parts. In a two-shot injection molding tool, the mold includes first and second mold halves that define one or more first cavities corresponding to a first part portion of a molded part. The first and second mold halves also define one or more second cavities corresponding to a second part portion of the molded part that surrounds at least part of the first part portion.

The first and second mold halves are closed and a first shot of molten plastic is injected into the first cavity between the first and second mold halves. One of the first and second mold halves is opened. One of the first and second mold halves is rotated and the first and second mold halves are closed. A second shot of molten plastic is injected into the second cavity around the first part portion, and then the part is ejected.

Some types of molded parts such as rear taillight lenses are made of plastic that is injected into a mold cavity using a direct shot gate. The direct shot gate is located within the confines of the first part portion of the injection molded part. When using direct shot gates, gate vestiges are typically formed. For some molded parts, the gate vestiges are acceptable. However, the quality of the injection molded plastic at the gate vestiges is different than in other locations. For other types of molded parts such as taillight lenses, the gate vestiges adversely affect optical characteristics of the injection molded part and are therefore unacceptable.

A similar problem occurs when the injection molded part is formed using a multi-shot injection molding process. For example, a first part portion of an injection molded part is injection molded by injecting a first shot (e.g., a clear transparent plastic) into the first cavity using a direct gate. Then, the mold is opened, rotated, and then a second shot (e.g., plastic having another color) is injected into the second cavity around the first part portion. However, the first part portion (and possibly the second part portion) of the injection molded part has a gate vestige.

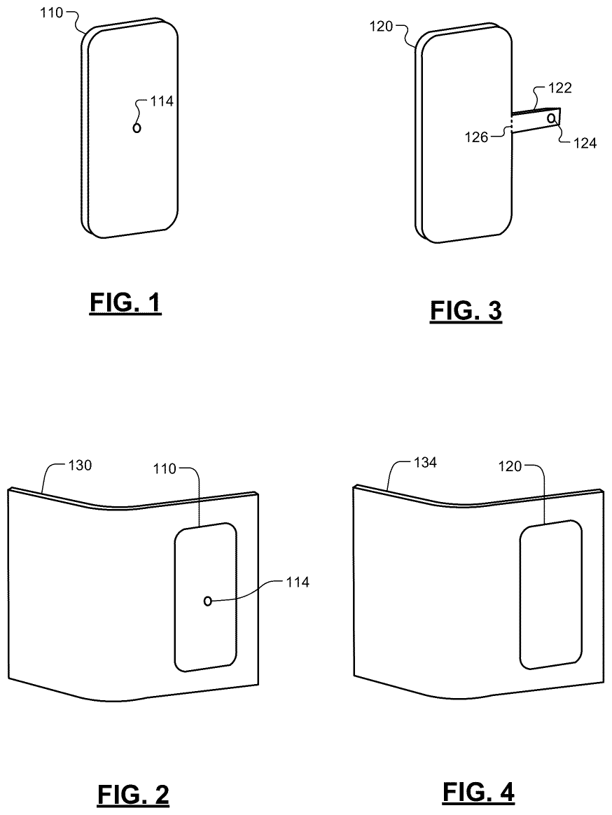

Referring now to FIGS. 1 and 2, a first part portion 110 of an injection molded part is formed using a multi-shot injection process. The first part portion 110 of the injection molded part is molded using a direct shot gate that leaves a gate vestige 114. As can be appreciated, the gate vestige 114 affects the visual quality and/or the optical performance of the molded part. In FIG. 2, a second part portion 130 of the injected molded part is formed around the first part portion 110.

Referring now to FIGS. 3 and 4, an example of a first part portion 120 of an injection molded part is formed using a multi-shot injection process according to the present disclosure. The first part portion 120 of the injection molded part includes a shot gate 124 formed in a projecting portion 122 defined in the first cavity and extending from an edge on one side of the first part portion 120. As will be described further below, a laser is used to remove the projecting portion 122 along dotted lines 126. In some examples, the projecting portion 122 is removed while the first part portion is still located in one of the mold halves.

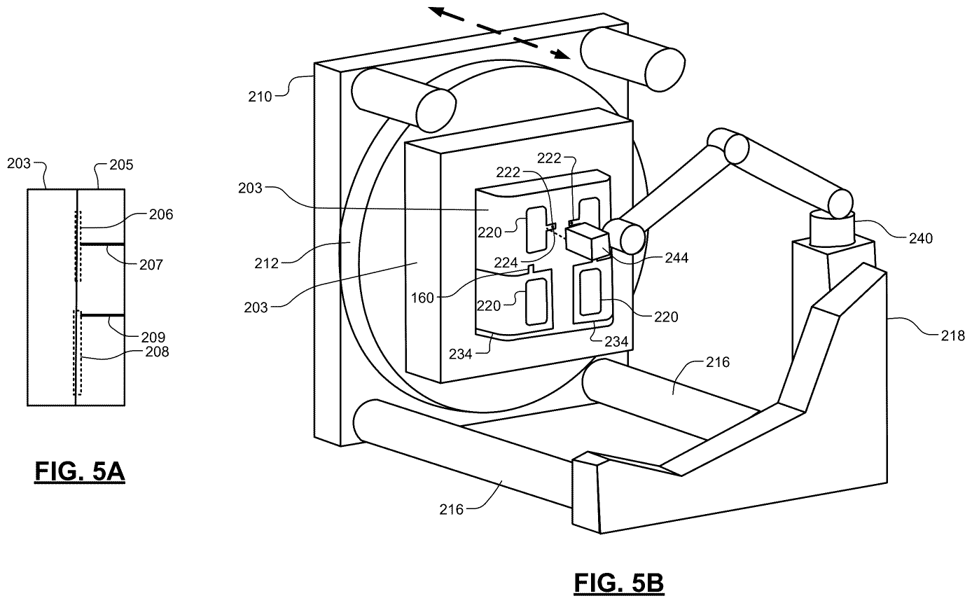

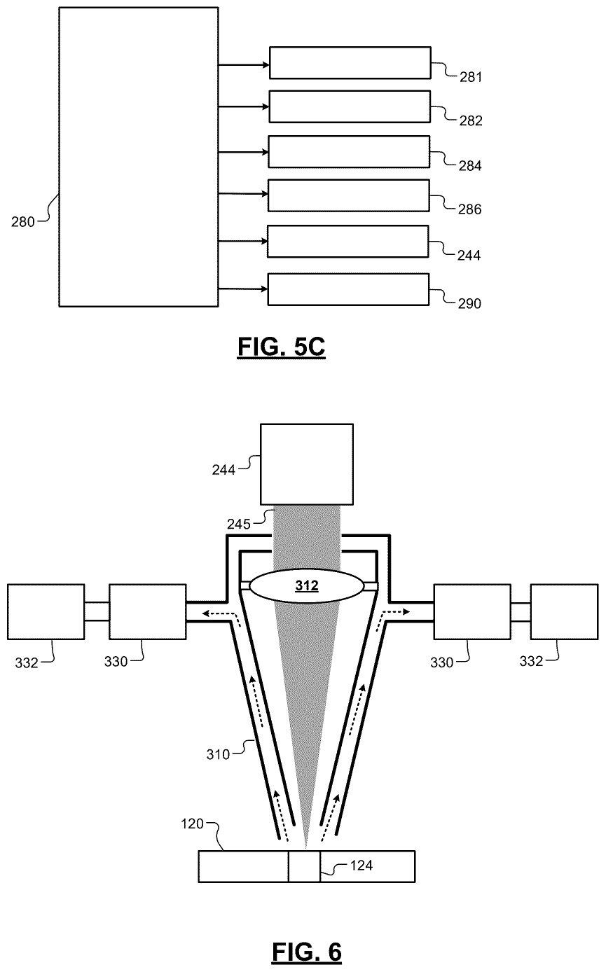

In FIG. 4, a second part portion 134 of the injected molded part is formed around the first part portion 120 after the projecting portion 122 is removed. In some examples, the second cavity also includes a projecting portion 160 defined in the second cavity and extending from an edge on one side of the second part portion (as can be seen in FIG. 5B). The projecting portion 160 can be removed in the molding tool or after removing the molded part from the molding tool.

Referring now to FIGS. 5A and 5B, a multi-shot injection molding tool is shown. In FIG. 5A, the multi-shot injection molding tool includes a first mold half 203 and a second mold half 205. One or both of the first mold half 203 and the second mold half define one or more first cavities 206 and one or more second cavities 208. A first channel 207 supplies molten plastic to the first shot gate in the projecting portion 122. A second channel 209 supplies molten plastic to the second shot gate in the projecting portion 160.

In FIG. 5B, the multi-shot injection molding tool includes a moving platen 210 that moves relative to and is guided by tie bars 216. In some examples, a hydraulic cylinder is used to move the moving platen 210 relative to a stationary platen 218 (partially shown).

A first rotating platen 212 rotates relative to the moving platen 210. A first mold half 203 is mounted on the rotating platen 212. In some examples, the tie bars 216 extend through the base fixture 210 to the stationary platen 218. The second mold half 205 is mounted on an inner surface of the stationary platen 218 facing the first mold half 203 (not shown). The first mold half 203 and/or the second mold half 205 define one or more first mold cavities 220 to mold the first part portion 120. The one or more first mold cavities 220 include a projecting portion 222 (that extends outside of a final edge of the molded part after trimming) to form the projecting portion 122. A shot gate 224 is located in the projecting portion 222. The first mold half 203 and/or the second mold half 205 define one or more second mold cavities 234 for molding the second part portion 134 around the first part portion 120.

In use, the one or more first mold cavities 220 mold the first part portion 120 of the molded part including the projecting portion 122. After molding the first part portion 120, the second mold half 205 is opened (as it would usually do before rotating for the second shot). Before or after rotation, a laser 244 is used to cut and remove the projecting portion 122 while the first part portion 120 is in the first mold half 203. In some examples, the robot 240 controls a position of the laser 244 to cut the projecting portion 122 along the edge of the first part portion 120 while the first part portion 120 is still held in the first mold half 203. After the projecting portion 122 and the shot gate 124 is removed, the first mold half 203 is rotated and the second mold half 205 is closed. The second shot is injected to surround at least part of the first part portion 120 without any remaining gate vestige from the first shot in the first part portion 120.

In FIG. 5C, a controller 280 can be used to automate the molding process. The controller 280 is configured to control one or more positioning devices 281 configured to open and close the second mold half and/or rotate the first mold half relative to the second mold half. In some examples, the positioning devices 281 include a hydraulic cylinder and/or a motor to move the platens and/or rotate the platens. The controller 280 is configured to control a first plastic injector 282 and a second plastic injector 284 to inject the first shot and the second shot of molten plastic. The controller 280 is configured to control the robot 286 to position the laser 244 during cutting of the projecting portion 122 and/or the projecting portion 160. The controller 280 is configure to control the laser 244. The controller 280 is configured to supply vacuum from a vacuum source 290 to remove vapor caused by laser trimming the projecting portion 122 and/or the projecting portion 160.

Referring now to FIG. 6, when the projecting portion 122 including the gate is removed while the first part portion 120 is located in the first mold half 203, a coaxial vacuum nozzle 310 may be used to remove vapor generated by laser cutting of the molded part to avoid contamination of a mold surface in the mold half 219. The laser 244 outputs a laser beam 245 onto a lens 312 that focuses the laser beam 245. The coaxial vacuum nozzle 310 is connected to a vacuum source 330 and exhaust 332 to evacuate the vapor.

In some examples, the taillight lens is made of plastic. In some examples, the plastic includes a polymer that can be vaporized using a laser without discoloring the surface or generating molten plastic where the cut is made. In some examples, the plastic includes polymethyl methacrylate (PMMA) or polycarbonate. PMMA absorbs light wavelengths longer than 4 micrometers (μm) which is in the far infrared region of the electromagnetic spectrum. The mold halves are typically made of steel, which has a lower absorption rate in the far infrared region.

In some examples, the laser includes a carbon dioxide (CO₂) laser having a wavelength around 10.6 μm to ensure absorption by the PMMA and reduce absorption on steel of the first mold half 203. In some examples, the laser uses power in a range from 10 Watts (W) to 1000 W. In some examples, the laser uses power in a range from 10 Watts (W) to 200 W. In some examples, the laser uses power in a range from 10 Watts (W) to 80 W. The vaporization cutting ensures a narrow cutting kerf and high cutting quality and low laser power (e.g., 60 W) can be used to avoid laser damage to the mold surface.

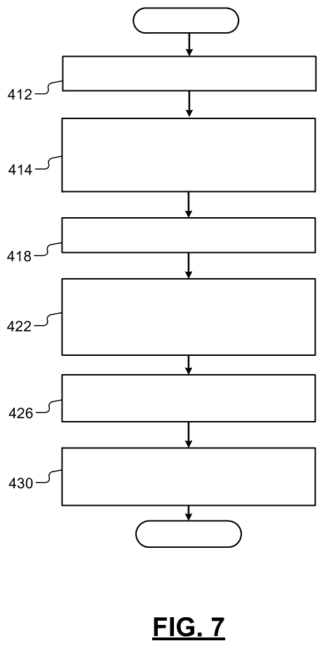

Referring now to FIG. 7, a method for molding a part is shown. At 412, the mold halves are closed. At 414, a first shot is injected into remote shot gate between first and second mold halves to mold the first part portion including the projecting portion. At 418, the second mold half is opened. At 422, a laser is used to cut the projecting portion from the first part portion while the first part portion is in the first mold half. At 426, the first mold half is rotated and the second mold half is closed over the first mold half. At 430, a second shot is injected around at least a portion of the first part portion.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A method for molding a part, comprising:
providing a mold including a first mold half and a second mold half defining a first cavity and a second cavity,
wherein the first cavity defines a shape of a first part portion and a projecting portion, and
wherein the second cavity defines a shape of a second part portion that at least partially surrounds the first part portion;
closing the first mold half and the second mold half;
injecting a first shot of molten plastic using a shot gate located along the projecting portion to mold the first part portion of the molded part;
opening the second mold half;
trimming the projecting portion using a laser while the first part portion is located in one of the first mold half and the second mold half;
rotating at least one of the first mold half and the second mold half;
closing the second mold half; and
injecting a second shot into the mold to form the second part portion.

2. The method of claim 1, wherein the first shot and the second shot comprise transparent plastic.

3. The method of claim 1, wherein the first shot and the second shot comprise polymethyl methacrylate (PMMA).

4. The method of claim 1, wherein the first shot and the second shot comprise polycarbonate.

5. The method of claim 1, wherein the first shot and the second shot comprise plastic having different colors.

6. The method of claim 1, wherein the laser comprises a carbon dioxide (CO₂) laser.

7. The method of claim 6, wherein the laser operates at a wavelength greater than 4 micrometers.

8. The method of claim 6, further comprising a robot configured to position the laser relative to the first mold half and the projecting portion of the first part portion.

9. The method of claim 1, further comprising using vacuum to evacuate vapor generated during laser trimming of the projecting portion.

10. The method of claim 1, wherein the molded part comprises a taillight lens.

11. A multi-shot injection molding tool for producing a molded part, comprising:
a mold including a first mold half and a second mold half defining a first cavity defines a shape of a first part portion and a projecting portion and a second cavity defining a shape of a second part portion that at least partially surrounds the first part portion;
a laser;
a positioning device;
a first injector;
a second injector; and
a controller configured to:
cause the positioning device to close the first mold half and the second mold half;
cause the first injector to inject a first shot of molten plastic using a shot gate located along the projecting portion to mold the first part portion of the molded part;
cause the positioning device to open the second mold half;
cause the positioning device and the laser to trim the projecting portion while the first part portion is located in one of the first mold half and the second mold half;
cause the positioning device to rotate at least one of the first mold half and the second mold half;
cause the positioning device to close the second mold half; and
cause the second injector to inject a second shot into the mold to form the second part portion.

12. The multi-shot injection molding tool of claim 11, wherein the first shot and the second shot comprise transparent plastic.

13. The multi-shot injection molding tool of claim 11, wherein the first shot and the second shot comprise polymethyl methacrylate (PMMA).

14. The multi-shot injection molding tool of claim 11, wherein the first shot and the second shot comprise polycarbonate.

15. The multi-shot injection molding tool of claim 11, wherein the first shot and the second shot comprise plastic having different colors.

16. The multi-shot injection molding tool of claim 11, wherein the laser comprises a carbon dioxide (CO₂) laser.

17. The multi-shot injection molding tool of claim 16, wherein the laser operates at a wavelength greater than 4 micrometers.

18. The multi-shot injection molding tool of claim 11, further comprising a vacuum nozzle configured to evacuate vapor generated by the laser during trimming of the projecting portion.

19. The multi-shot injection molding tool of claim 11, wherein the molded part comprises a taillight lens for a vehicle.
